(19) United States
(12) Patent Application Publication
(10) Pub. No.: US 2020/0360739 A1
(43) Pub. Date: Nov. 19, 2020

(54) SUSPENSION TRAUMA RELIEF SYSTEM

(71) Applicant: Buckingham Manufacturing Company, Inc., Binghamton, NY (US)

(72) Inventor: Kevin Truesdell, Binghamton, NY (US)

(73) Assignee: Buckingham Manufacturing Company, Inc., Binghamton, NY (US)

(21) Appl. No.: 16/876,795

(22) Filed: May 18, 2020

Related U.S. Application Data
(60) Provisional application No. 62/848,673, filed on May 16, 2019.

(51) Int. Cl. A62B 35/00; A44B 13/00

(52) U.S. Cl. CPC A62B 35/0025; A44B 13/0029

(57) ABSTRACT

A suspension trauma relief system for use with (and configured to connect to) a body harness and including, but not limited to, a double/dual pouch—each of which is attached to a strap assembly, where at least one of the straps (and preferably both straps) have an adjustment mechanism attached thereto, which can be positioned adjacent to a user and harness worn and adjusted by a user when in use.

### CROSS REFERENCE TO RELATED APPLICATIONS

This application claims priority to U.S. Provisional Patent Application Ser. No. 62/848,673 filed on May 16, 2019 which is incorporated herein by reference in its respective entirety.

### BACKGROUND

### 1. Field of the Invention

The present invention relates generally to a suspension trauma relief system, and more particularly to a double/dual pouch and dual strap assembly, each of which includes a length adjustment mechanism that can be actuated while in use with (and configured to connect to) a body harness.

### 2. Description of the Related Art

Harnesses are used in the event that a climber falls during a climb. However, freely hanging with a harness can cause orthostatic intolerance, also known as suspension trauma. Conventional suspension trauma relief systems are generally designed to alleviate the effects of orthostatic intolerance. See, for example, U.S. Pat. No. 8,919,496, providing additional background on suspension trauma and describing a conventional suspension trauma relief assembly. Conventional suspension trauma relief systems do not allow a user to adjust the system while the system is in use. Therefore, a user would need to take the system off, opening themselves up to injury in order to adjust the system. There is a need for an improved suspension trauma relief system that is configured to be adjustable when in use.

Description of the Related Art Section Disclaimer: To the extent that specific patents/publications/products are discussed above in this Background Section or elsewhere in this Application, these discussions should not be taken as an admission that the discussed patents/publications/products are prior art for patent law purposes. For example, some or all the discussed patents/publications/products may not be sufficiently early in time, may not reflect subject matter developed early enough in time and/or may not be sufficiently enabling so as to amount to prior art for patent law purposes. To the extent that specific patents/publications/products are discussed above in this Background Section and/or throughout the application, the descriptions/disclosures of which are all hereby incorporated by reference into this document in their respective entirety(ies).

### SUMMARY

It is therefore a principal object and advantage of the present invention to provide a suspension trauma relief system that eliminates one or more of the problems/issues associated with conventional products. In particular, the present disclosure is directed to inventive devices and systems structured and/or configured to allow for the adjustability of a suspension trauma relief system while in use based on a new and unique structural configuration. A particular non-limiting goal of the utilization of the embodiments and implementations herein is to provide a suspension trauma relief system for use with (and configured to connect to) a body harness and including, but not limited to, a double/dual pouch—each of which is attached to a strap assembly, where at least one of the straps, and preferably both straps, have an adjustment mechanism attached thereto, which can be positioned adjacent to a user and harness worn by a user when in use. The adjustment mechanism can comprise a buckle, a portion of the strap, and a keeper. The keeper element distally positioned on the strap from the buckle. The keeper element can be configured to attach to the tail of an adjustment strap and keep the tail on the main strap before and after adjustment. In brief, the length of each respective strap can be shortened by pulling the tails in the distal direction away from the harness to shorten the strap as may be needed by a particular user. The tail can be pulled in the proximal direction to lengthen a respective strap.

The system of an embodiment is configured to alleviate the effects of orthostatic intolerance by allowing the user to immediately deploy a body support system that allows for improved blood circulation and the ability to move and flex muscles until rescued. The suspension trauma relief system of an embodiment is configured for use and fully adjustable by any sized user and can be used either right-handed or left-handed. The pouch/bag can be attached to any full body harness, made of a single-layered FR material, and the system as a whole can be configured and constructed to meet the Electric Arc Performance Requirements of the ASTM F887 Standard.

### BRIEF DESCRIPTION OF THE FIGURES

The present invention will be more fully understood and appreciated by reading the following Detailed Description in conjunction with the accompanying drawings. The accompanying drawings illustrate only typical embodiments of the disclosed subject matter and are therefore not to be considered limiting of its scope, for the disclosed subject matter may admit to other equally effective embodiments.

Reference is now made briefly to the accompanying drawings, in which:

FIG. 1A is a perspective view of an example of a first pouch of the suspension trauma relief system.

FIG. 1B is a perspective view of an example of a second pouch of the suspension trauma relief system.

FIG. 2 is a perspective view of an example of the suspension trauma relief system in the deployed configuration.

FIG. 3 is a close-up view of an example of the distal ends of the straps of the suspension trauma relief system.

FIG. 4 is a close-up view of an example of the suspension trauma relief system.

FIG. 5A is a perspective view of an example of the suspension trauma relief system on a body harness.

FIG. 5B is a perspective view of an example of the suspension trauma relief system on a body harness.

FIG. 6 is a perspective view of an example of the suspension trauma relief system on a body harness.

FIG. 7 is a perspective view of an example of the suspension trauma relief system on a body harness.

FIG. 8 is a perspective view of a user using an example of the suspension trauma relief system.

FIG. 9 is a perspective view of a user using an example of the suspension trauma relief system.

FIG. 10 is a perspective view of a user using an example of the suspension trauma relief system.

FIG. 11 is a close-up view of an example of the suspension trauma relief system.

FIG. 12 is a perspective view of an example of an attachment device.

FIG. 13 is a close-up view of an example of the suspension trauma relief system.

FIG. 14 is a close-up view of an example of the suspension trauma relief system.

FIG. 15A is a perspective view of the suspension trauma relief system.

FIG. 15B is a perspective view of the suspension trauma relief system.

### DETAILED DESCRIPTION

Aspects of the present invention and certain features, advantages, and details thereof, are explained more fully below with reference to the non-limiting examples illustrated in the accompanying drawings. Descriptions of well-known structures are omitted so as not to unnecessarily obscure the invention in detail. It should be understood, however, that the detailed description and the specific non-limiting examples, while indicating aspects of the invention, are given by way of illustration only, and are not by way of limitation. Various substitutions, modifications, additions, and/or arrangements, within the spirit and/or scope of the underlying inventive concepts will be apparent to those skilled in the art from this disclosure.

While embodiments of the present invention have been particularly shown and described with reference to certain exemplary embodiments, it will be understood by one skilled in the art that various changes in detail may be effected therein without departing from the spirit and scope of the invention as defined by claims that can be supported by the written description and drawings. Further, where exemplary embodiments are described with reference to a certain number of elements it will be understood that the exemplary embodiments can be practiced utilizing either less than or more than the certain number of elements. If elements are shown in a particular Figure discussed below are not specifically identified with respect to that Figure, the elements should be sufficiently identified with respect to at least one other Figure.

In one example the suspension trauma relief system 10 generally comprises a strap comprising a distal end and a proximal end, wherein the strap is adjustable between a shorter length and a longer length; an attachment device attached to the distal end of the strap; and an adjustment mechanism positioned along the strap adjacent to the proximal end of the strap, comprising a buckle, a portion of the strap is doubled back on itself, and a keeper, wherein the adjustment mechanism is configured to allow the strap to move between the shorter length and the longer length, such that when the portion of the strap doubled back on itself increases the strap is the shorter length and when the portion of the strap doubled back on itself decreases the strap is the longer length.

In another example, the suspension trauma relief comprises a first strap and a second strap each comprising a distal end and a proximal end, and wherein each strap is adjustable between a shorter length and a longer length; a first attachment device attached to the distal end of the first strap and a second attachment device attached to the distal end of the second strap; wherein the first attachment device and the second attachment device are configured to be releasably connected to one another; a first adjustment mechanism positioned along the first strap adjacent to the proximal end of the first strap, comprising a buckle, a portion of the first strap is doubled back on itself, and a keeper, wherein the first adjustment mechanism is configured to allow the first strap to move between the shorter length and the longer length, such that when the portion of the first strap doubled back on itself increases the first strap is the shorter length and when the portion of the strap doubled back on itself decreases the length of the first strap is the longer length; and a second adjustment mechanism positioned along the second strap adjacent to the proximal end of the second strap, comprising a buckle, a portion of the second strap is doubled back on itself, and a keeper, wherein the second adjustment mechanism is configured to allow the second strap to move between the shorter length and the longer length, such that when the portion of the second strap doubled back on itself increases the strap is the shorter length and when the portion of the second strap doubled back on itself decreases the length of the second strap is the longer length.

One method of using a suspension trauma relief system comprises the steps of removing the straps from pouches located on a body harness; connecting the distal ends of the straps to one another using the attachment devices; placing the user's feet on straps in order to redistribute user's body weight; and adjusting the straps to the user's desired length. The method can further comprise the step of placing the pouches on the user's body harness.

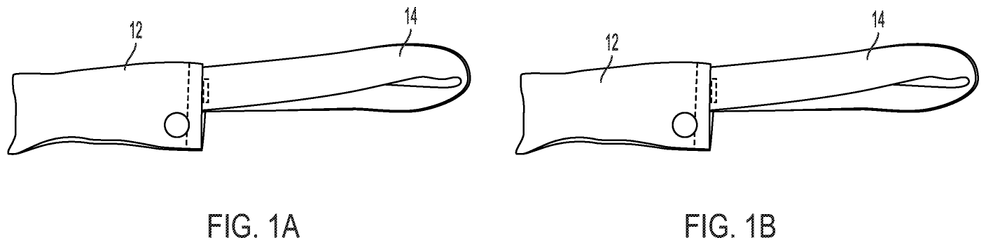

Referring now to FIG. 1A, there is shown a perspective view of an example of a first pouch 12 with a first strap 14, representing a portion of suspension trauma relief system 10 in the undeployed configuration. Referring to FIG. 1B, there is shown a perspective view of an example of a second pouch 12 with a second strap 14, representing another portion of suspension trauma relief system 10 in the undeployed configuration. First and second straps 14 can be used conjunction with one another to form one system 10. Pouch 12 stores strap 14 when in the undeployed configuration. Pouch 12 can further comprise a closure mechanism such as but not limited to a zipper, snap, hook and loop. A user can place strap 14 into pouch 12 by any suitable means such as rolling, stuffing, or using a retractable device within pouch 12. The user can use system 10 without pouch 12.

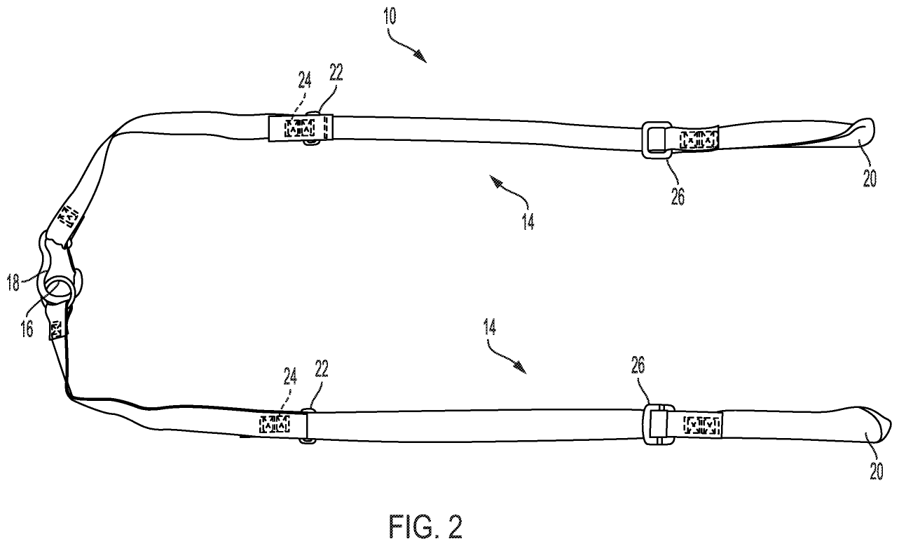

Referring to FIG. 2, there is shown a perspective view of an example of first strap 14 connected to second strap 14 of suspension trauma relief system 10 in the deployed configuration. Strap 14 can be made of webbing or other suitable material in the art. Strap 14 can also be of any suitable length to be placed and adjusted around a user's legs. As shown, first and second strap 14 have been removed from respective pouch 12 and first strap 14 is connected to second strap 14 at the respective distal strap ends which comprise an attachment device. Proximal ends 20 of strap 14, attaches to a harness when in use. Strap 14 further comprises an adjustment mechanism. The adjustment mechanism is adjacent to proximal end of strap 14, and thus to the user and to the harness as compared to conventional devices in a preferable embodiment.

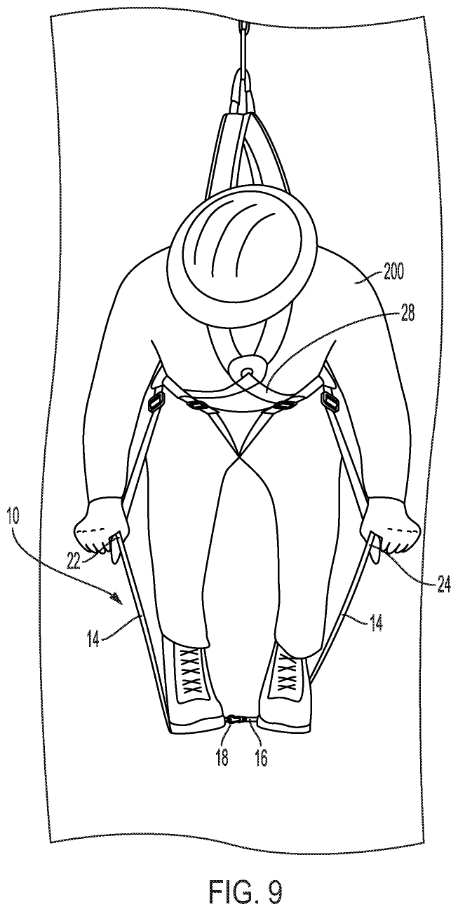

Each adjustment mechanism can include a keeper 22, a tail 24, a portion of strap 14 doubled back on itself, a buckle 26. Buckle can be accomplished by other adjustment mechanism, as should be understood by a person of skill in the art in conjunction with a review of this disclosure. Positioned distally to buckle 26 on at least one strap 14 (and as shown, to both), a keeper 22 is attached to strap 14 and to a distal end portion of a tail 24 of an adjustment mechanism of strap 14. Tail 24 being formed from a portion of strap 14 being doubled back on itself. The distal end portion of the tail 24 can be pulled distally by a user to shorten a respective strap 14 (see, e.g., FIG. 9) The portion of the adjustment portion of strap 14 positioned proximally to the proximal end of the keeper 22 can be pulled to lengthen the strap 14 (as should be understood by a person of ordinary skill in the art in conjunction with a review of this disclosure). Keeper 22 can be configured to keep tail 24 in line with the body of the strap 14 to prevent tangling (as should be understood by a person of ordinary skill in the art in conjunction with a review of this disclosure).

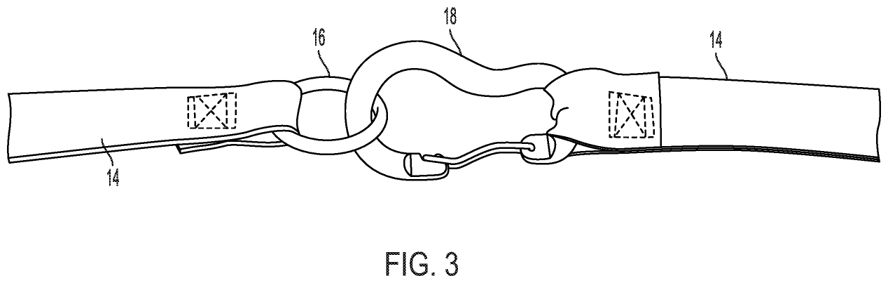

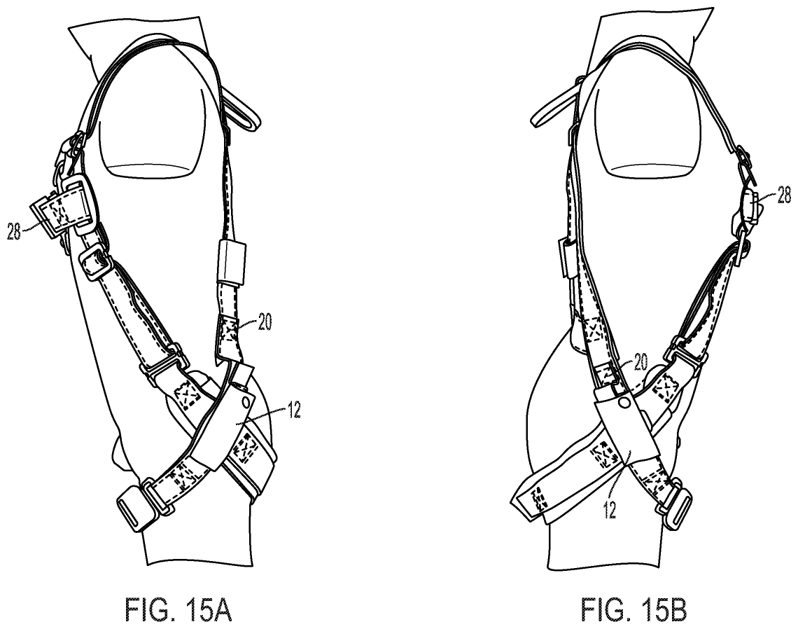

Referring to FIG. 3, a close-up perspective view of the distal strap ends of each strap 14 are shown attached to each other in accordance with an embodiment. As shown in FIG. 3, each strap 14 has an attachment device on the distal end. In the example shown, one of the distal strap ends includes a carabiner 18 and the other distal strap end includes a ring 16 attached to carabiner 18. Other attachment devices can be used such as but not limited to a loop, two carabiners 18, snaps, or hooks. There is also shown in FIG. 15, an example of an attachment device wherein the attachment device is a carbineer 18. System 10 can also be one strap 14 attached to one side of the harness 28 with the attachment device being attached back to the other side of harness 28 when deployed.

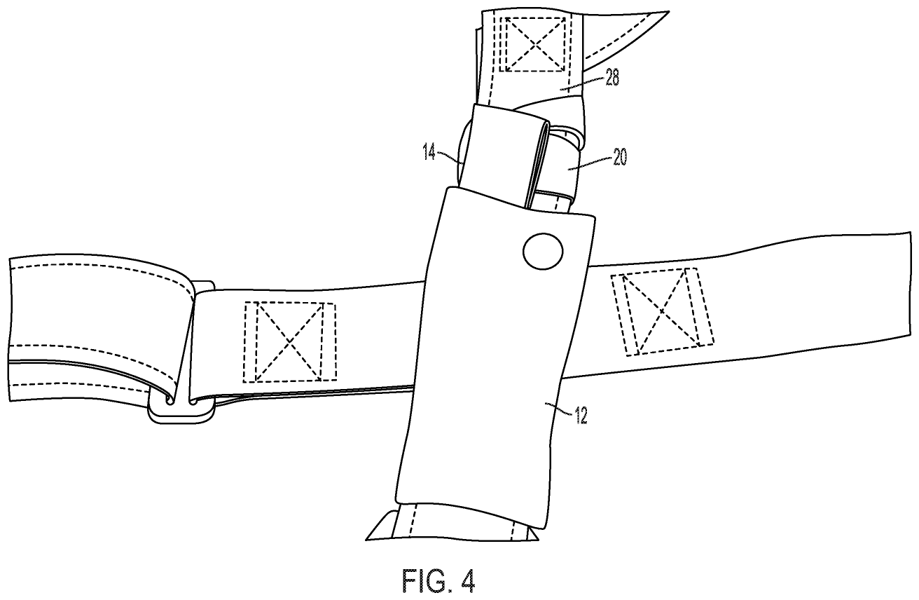

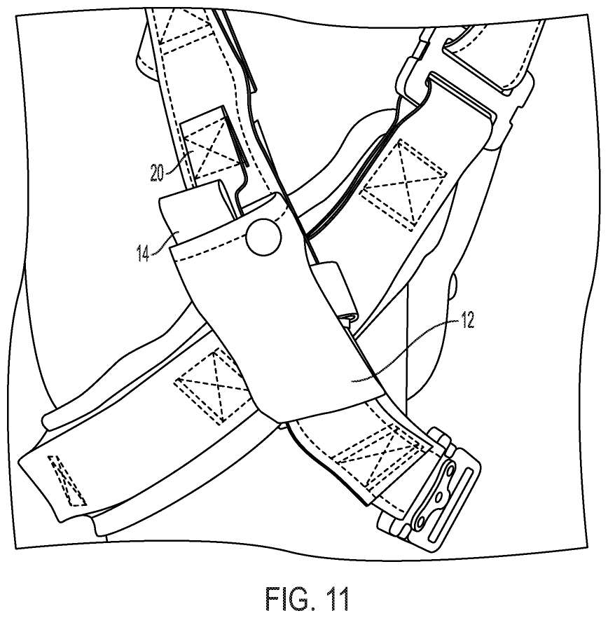

System 10 can be retrofitted to a conventional harness 28 or can be made permanently attached with the harness 28. Referring to FIG. 4, a close-up perspective view of a pouch 12 connected to harness 28 via proximal end 20 of strap 14 is shown according to an embodiment. In some embodiments, a loop is formed at least one proximal end 20 of one of straps 14. Strap 14 can also be attached by any means suitable in the art such as but not limited to rivet, wrap, stitching, clamp, or buckle. In FIG. 11, there is shown close-up right-side view of an example of harness 28 with a permanently attached strap 14 attached to harness 28. In this example strap 14 is attached to harness 28 via stitching. Pouch 12 can be removably or permanently attached to strap 14 and/or directly to harness 28.

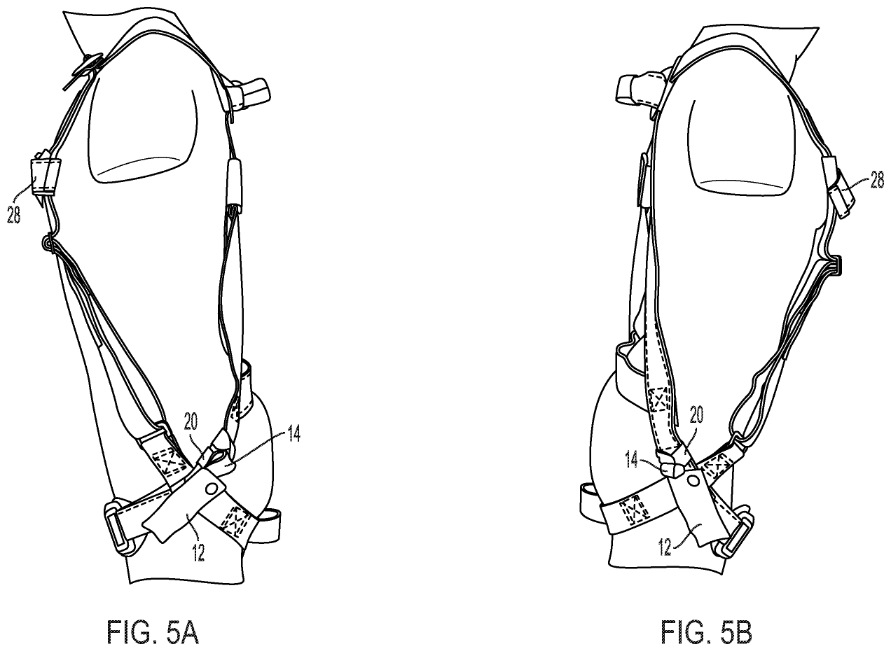

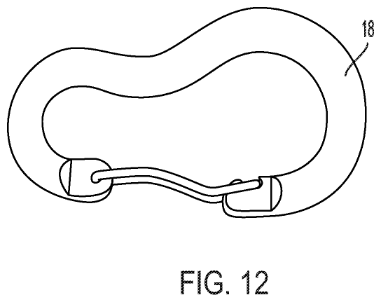

Referring to FIG. 5A, a left side view of a harness 28 with a first pouch 12 attached to harness 28 via proximal end 20 of strap 14 is shown according to an embodiment. Typically, a user would attach a strap 14 to both sides of harness 28. Referring to FIG. 12A, a left side view of a harness 28 with a permanently attached first pouch 12 attached to the harness via proximal end 20 of strap 14 is shown according to an embodiment. Referring to FIG. 5B, a right-side view of the harness 28 with a second pouch 12 attached to harness 28 via proximal end 20 of strap 14 is shown according to an embodiment. Referring to FIG. 12B, a right-side view of the harness 28 with a permanently attached second pouch 12 attached to harness 28 via proximal end 20 of strap 14 is shown according to an embodiment.

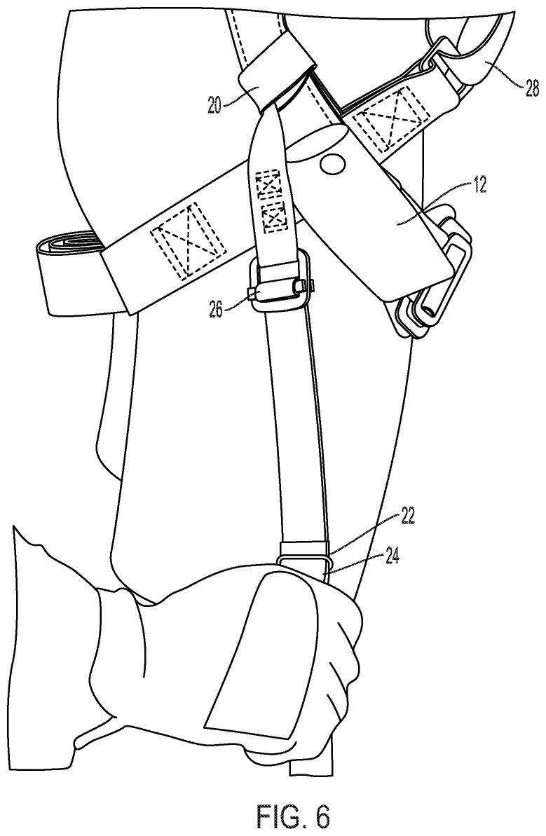

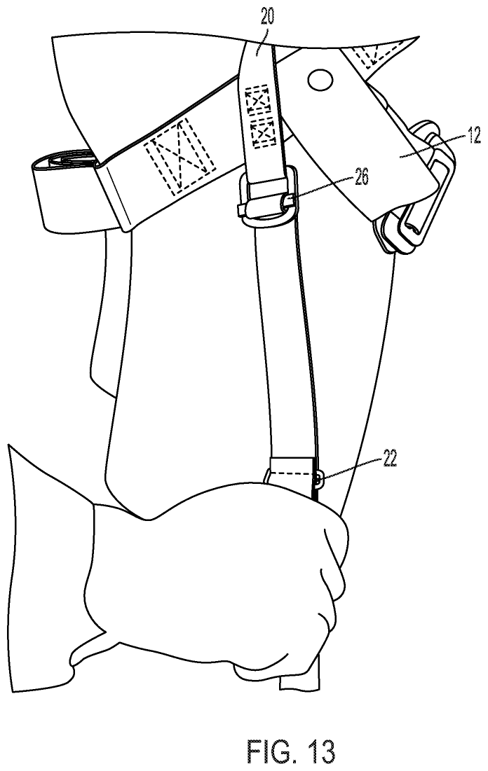

Referring to FIG. 6, a close-up right-side view of the harness 28 with second pouch 12 attached to harness via proximal end 20 of strap 14 is shown according to an embodiment where strap 14 is attached using a loop. Similarly, referring now to FIG. 13, there is shown a close-up right-side view of harness 28 with a permanently attached strap 14 attached to harness. Here, strap 14 is permanently attached to harness 28 by proximal end 20 via stitching. In both FIGS. 6 and 13 strap 14 is in a deployed position. The user is also adjusting the length of the strap using the adjustment mechanism. Tail 24 is shown being grasped by a user to shorten the length of strap 14. During this process strap 14 slides through buckle 26 and is being held by keeper 22. The portion of strap 14 between buckle 26 and keeper 22 is doubled back on itself.

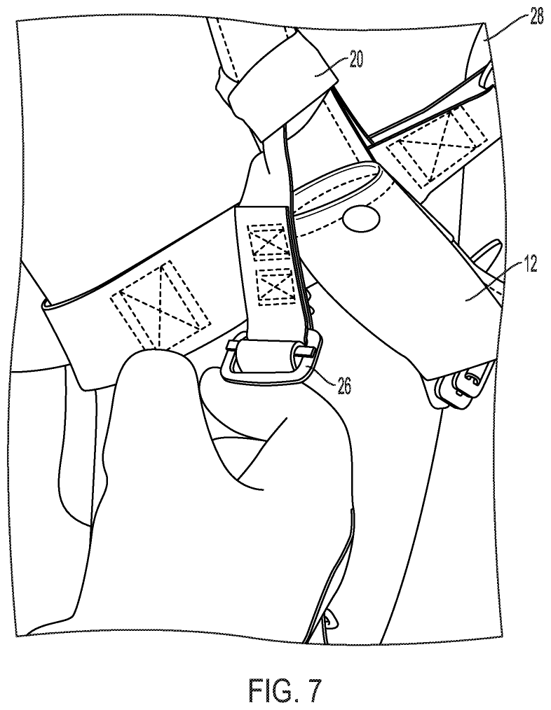

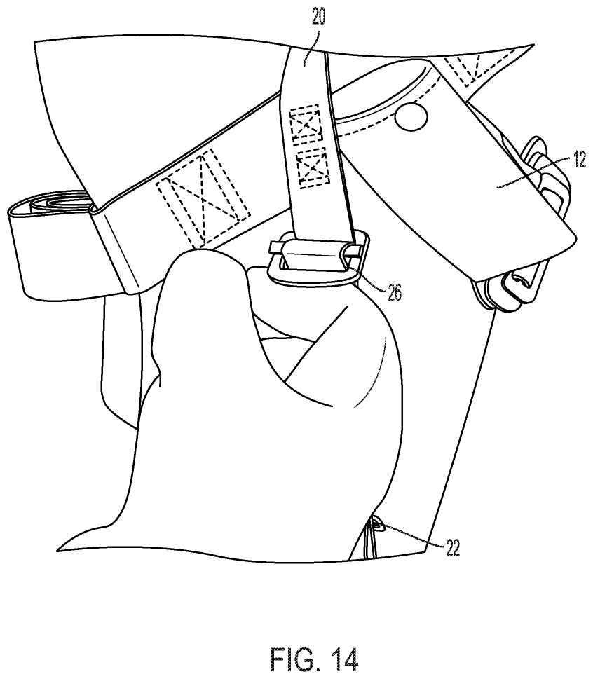

Referring to FIG. 7, a further close-up right-side view of harness 28 with the second pouch 12 attached to harness 28 via proximal end 20 of strap 14 is shown according to an embodiment. As shown, proximal end 20 of strap 14 is passed over a portion of harness 28 and back through a loop formed at proximal end 20. Similarly, referring now to FIG. 14, there is shown a close-up right-side view of harness 28 with a permanently attached strap 14 attached to harness 28. In both FIGS. 7 and 14, the user is shown using the adjustment mechanism to increase the length of the strap 14. Here, the user is pulling up on buckle 26 to allow doubled over portion of the strap 14 to slide back through buckle 26, ultimately increasing the length of the non-doubled over portion of strap 14.

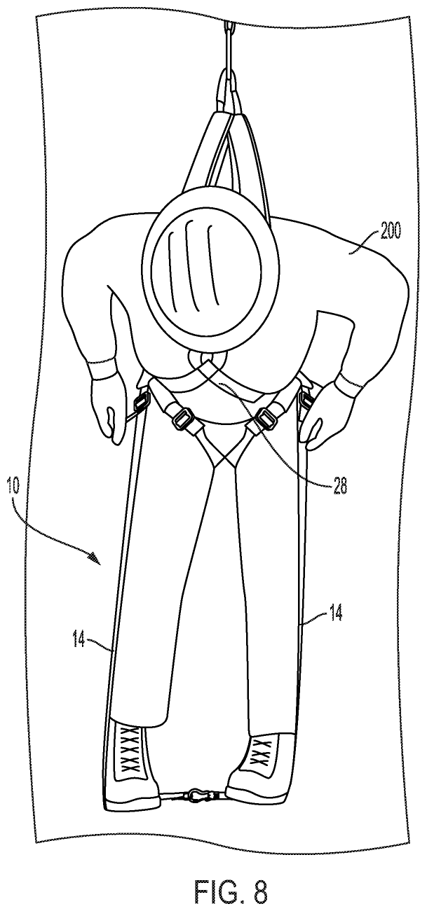

Referring to FIG. 8, user 200 is shown using suspension trauma relief system 10 according to an embodiment. As shown, user 200 is wearing harness 28 that is attached at the back to a lanyard or anchor. The proximal portions of each of two straps 14 are attached to the harness 28, and attachment devices 16, 18 of each strap 14 are attached to each other. User 200 is shown adjusting adjustment mechanism of each strap 14. As shown the adjustment mechanism is placed near the user's hips. This allows the user to adjust the length of strap 14 while wearing system 10.

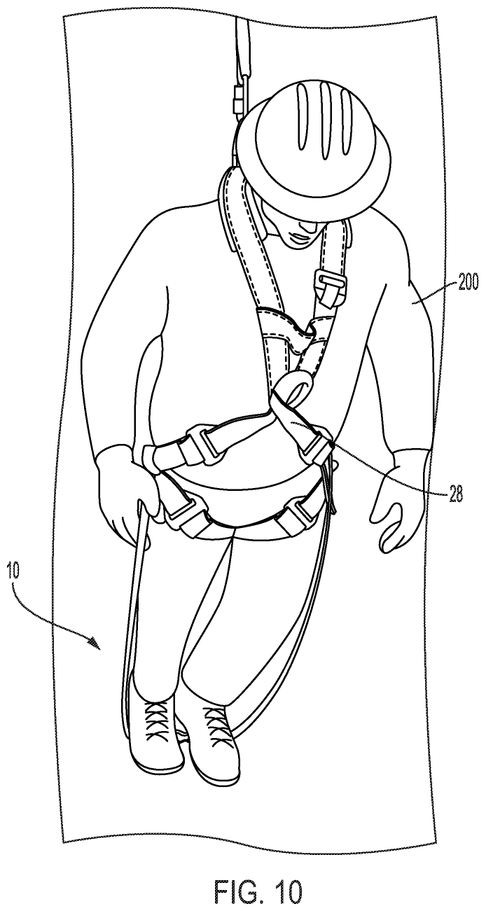

Referring to FIG. 9, user 200 of FIG. 5 is shown using suspension trauma relief system 10 according to an embodiment. In particular, user 200 is shown pulling distally on each tail 24 to shorten the length of each strap 14. Referring to FIG. 10, user 200 is shown using suspension trauma relief system 10 according to an embodiment. In particular, user 200 is shown suspended and putting all of his weight on the adjusted suspension trauma relief system 10 according to an embodiment.

1. A suspension trauma relief system for use with a body harness, comprising:
a strap comprising a distal end and a proximal end, wherein the strap is adjustable between a shorter length and a longer length;
an attachment device attached to the distal end of the strap; and
an adjustment mechanism positioned along the strap adjacent to the proximal end of the strap, comprising a buckle, a portion of the strap is doubled back on itself, and a keeper, wherein the adjustment mechanism is configured to allow the strap to move between the shorter length and the longer length, such that when the portion of the strap doubled back on itself increases the strap is the shorter length and when the portion of the strap doubled back on itself decreases the strap is the longer length.

2. The suspension trauma relief system of claim 1, further comprising a pouch dimensioned to store the strap within it.

3. The suspension trauma relief system of claim 2, further wherein the pouch is permanently affixed to the body harness with stitching.

4. The suspension trauma relief system of claim 2, wherein the pouch is removably attached to the body harness by a loop.

5. The suspension trauma relief system of claim 1, wherein the attachment device is a carabiner.

6. The suspension trauma relief system of claim 1, wherein the attachment device is a ring.

7. The suspension trauma relief system of claim 1, wherein the keeper connects the strap with the portion of the strap doubled back on itself.

8. The suspension trauma relief system of claim 1, wherein the keeper is at a more distal position along the strap than the buckle.

9. A suspension trauma relief system for use with a body harness, comprising:
a first strap and a second strap each comprising a distal end and a proximal end, and wherein each strap is adjustable between a shorter length and a longer length;
a first attachment device attached to the distal end of the first strap and a second attachment device attached to the distal end of the second strap; wherein the first attachment device and the second attachment device are configured to be releasably connected to one another;
a first adjustment mechanism positioned along the first strap adjacent to the proximal end of the first strap, comprising a buckle, a portion of the first strap is doubled back on itself, and a keeper, wherein the first adjustment mechanism is configured to allow the first strap to move between the shorter length and the longer length, such that when the portion of the first strap doubled back on itself increases the first strap is the shorter length and when the portion of the strap doubled back on itself decreases the length of the first strap is the longer length; and
a second adjustment mechanism positioned along the second strap adjacent to the proximal end of the second strap, comprising a buckle, a portion of the second strap is doubled back on itself, and a keeper, wherein the second adjustment mechanism is configured to allow the second strap to move between the shorter length and the longer length, such that when the portion of the second strap doubled back on itself increases the strap is the shorter length and when the portion of the second strap doubled back on itself decreases the second strap is the longer length.

10. The suspension trauma relief system of claim 9, further comprising a first pouch and a second pouch dimensioned to store the first strap and second strap within the respective first and second pouch.

11. The suspension trauma relief system of claim 10, further wherein the first and second pouches are permanently affixed to the body harness by stitching.

12. The suspension trauma relief system of claim 10, wherein the first and second pouches are removably attached to the body harness with a loop.

13. The suspension trauma relief system of claim 9, wherein one of the first or second attachment devices is a carabiner.

14. The suspension trauma relief system of claim 9, wherein one of the first or second attachment devices is a ring.

15. The suspension trauma relief system of claim 9, wherein the first and second adjustment mechanisms are a buckle.

16. The suspension trauma relief system of claim 9, wherein the first and second strap are individually adjustable.

17. The method of using a suspension trauma relief system, comprising the steps of:
removing the straps from pouches located on a body harness;
connecting the distal ends of the straps to one another using the attachment devices;
placing the user's feet on straps in order to redistribute user's body weight; and
adjusting the straps to the user's desired length.

18. The method of claim 17, further comprising the step of placing the pouches on the user's body harness.
